(19) United States
(12) Patent Application Publication
(10) Pub. No.: US 2016/0092518 A1
(43) Pub. Date: Mar. 31, 2016

(54) DYNAMIC RESULTS

(71) Applicant: Microsoft Corporation, Redmond, WA (US)

(72) Inventors: Yekaterina Grabar, Seattle, WA (US); Daniel Dole, Seattle, WA (US)

(73) Assignee: Microsoft Corporation, Redmond, WA (US)

(21) Appl. No.: 14/496,251

(22) Filed: Sep. 25, 2014

(51) Int. Cl. G06F 17/30

(52) U.S. Cl. CPC G06F 17/30554; G06F 17/3053; G06F 17/30241

(57) ABSTRACT

Architecture that enables increased content presentation as part of the results where the results returned are insufficient to fill the results page being presented. An analysis component can be provided and configured to compute excess presentation space of a results area, where the results area comprises map results having content presented in association with a map. A content component presents additional content in the results area based on availability of the excess presentation space of the results area. The additional content and map results are limited to a maximum presentation space of the results area. The additional content includes portions of content individually relevant to corresponding map results and the portions of content are distributed in equivalent amounts of space among the map results.

### BACKGROUND

Searching is a primary tool employed by users in many different facets of data discovery. However, if a user performs a search where only a short list of results is returned, an opportunity is lost to enhance the user experience in cases where, for example, only three results are returned when a greater number of results can be accommodated on the results page.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables increased content presentation where the results returned are insufficient to fill the page being presented, which further enables the technical effects of at least 1) improved user efficiency in readily identifying the desired information, and 2) increased user interaction performance based on the increased amount of content presented. This capability finds particular application to mapping programs where the results returned may more than likely be insufficient to fill the results page presented. For example, additional content information for the results can be presented because there is more unused space (e.g., where the capability exists to return up to ten results on one page of results, but there were only three results available, there is unused space equivalent to seven results).

Implemented as a system, an analysis component can be provided and configured to compute excess presentation space of a results area, where the results area comprises map results having content presented in association with a map. The system can further comprise a content component configured to present additional content in the results area based on availability of the excess presentation space of the results area. The additional content and map results are limited to a maximum presentation space of the results area. The additional content includes portions of content individually relevant to corresponding map results and the portions of content are distributed in equivalent amounts of space among the map results. The additional content is apportioned among the map results. The additional content is apportioned among the map results based on rank of the map results. The additional content relates to geographical information of one or more points of interest identified in the map, the one or more points of interest visually associated with the map results. The content component is configured to access a single type of the additional content for presentation in association with the map results.

Implemented as a method, the method can comprise acts of computing excess presentation space of a results area in which search results are presented, accessing additional content relevant to the search results, and presenting the additional content in the results area in association with the search results based on availability of the excess presentation space.

The method can further comprise acts of limiting the additional content and the search results to the results area, restricting the additional content to non-advertising content, allocating result space for a given search result based on rank of the search result, presenting the additional content of a given search result as relates to geographical information of a point of interest associated with the given search result, presenting additional geographical information as the additional content to geographical results of a mapping application, and accessing a single type of the additional content for presentation in association with the search results.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a method in accordance with the disclosed architecture.

FIG. 3 illustrates an alternative method in accordance with the disclosed architecture.

FIG. 4 illustrates a diagram of a change in views of search results with a corresponding change of view of an associated map.

FIG. 5 illustrates a block diagram of a computing system that executes dynamic results in accordance with the disclosed architecture.

### DETAILED DESCRIPTION

The disclosed architecture computes unused space of a results section in which search results are presented as relate to geographical points of interest, selects additional content relevant to the search results based on the unused space such that presentation of both the additional content and the search results does not exceed dimensions of the results section, and presents both the additional content and the search results in the results section and in association with a map of the geographical points of interest.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

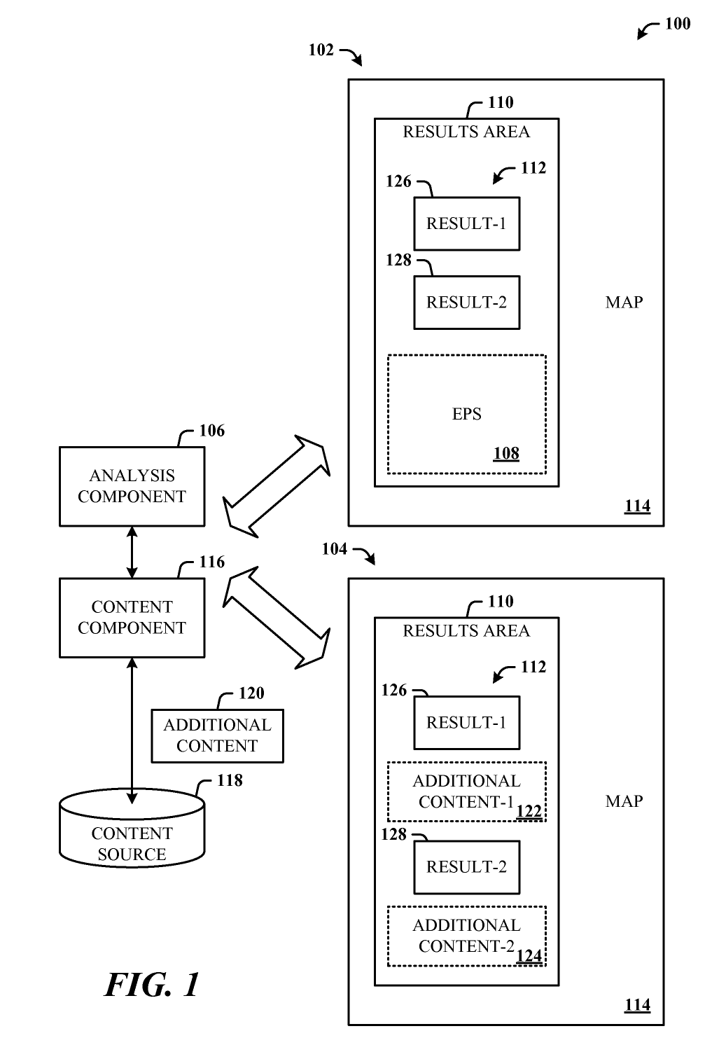

FIG. 1 illustrates a system 100 in accordance with the disclosed architecture. The system 100 is described in combination with a top view 102 and a bottom view 104 of a possible presentation. The system 100 can include an analysis component 106 configured to compute excess presentation space (EPS) 108 of a results area 110. The results area 110 comprises map results 112 each having content, and the results area 110 can be presented in association with a map 114.

In the top view 102, the results area 110 is shown as being filled with the results 112 in a top-down ranking. Thus, there will not be space above the top-ranked result that is determined to be excess space. Additionally, the results 112 will be presented and spaced such that no excess space will exist between the results 112. Thus, in a typical case (e.g., English language countries), the EPS 108 will occur after the last (or lowest ranked or bottom) result. It is to be understood, however, that where utilized in countries using different languages and ways of reading content and search results, the EPS 108 may be computed as is located differently relative to the results 112 such as above the results 112, or on either side of the results 112.

A content component 116 can be provided and configured to select (from a content source 118, such as a search engine infrastructure, mapping engine infrastructure, etc.) and present additional content 120 (comprising first Additional Content-1 122 and second Additional Content-2 124, as depicted in the bottom view 104 of FIG. 1) in the results area 110 based on availability of the EPS 108 of the results area 110.

Once the EPS 108 is determined, further computation by the analysis component 106 can include apportioning the EPS 108 among the results 112. For example, for a total of two results (a first result 126 and a second result 128) of the results 112, each result (126 or 128) can be apportioned one half of the total EPS 108, for the additional content. Thus, the original content of the first result 126 is then expanded (or appended) to include the first Additional Content-1 122 and the original content of the second result 128 is expanded (or appended) to include the second Additional Content-2 124.

In other words, the additional content 120 and map results 112 are limited to a maximum presentation space of the results area 110. The additional content 120 is non-advertising content. The additional content 120 includes portions of content (e.g., first Additional Content-1 and second Additional Content-2) individually relevant to corresponding map results 112 and the portions of content (e.g., first Additional Content-1 and second Additional Content-2) of the additional content 120 are distributed in equivalent amounts of space among the map results 112.

The additional content 120 can be apportioned (e.g., equally by space) among the map results 112. The additional content 120 can be apportioned among the map results 112 based on rank of the map results 112. In other words, a highest ranked result (e.g., the first result 126) can be allocated more space than a lower ranked result (e.g., the second result 128). The first result 126 can be allocated sixty-five percent of the total EPS 108 and the second result 128 can be allocated the remaining thirty-five percent of the total EPS 108. The allocations can be computed using an allocation algorithm, for example, that computes the appropriate allocation for each of many results, and based on the total space of the results area 110.

The additional content 120 can relate to geographical information (e.g., geographical coordinates, name of the point of interest, address information, etc.) of one or more points of interest identified in the map 114. The one or more points of interest can be visually associated with the map results such that a result is annotated with a graphical indicator (e.g., a colored button) that assists the user to quickly visually identify the associated point of interest on the map 114. In another implementation, the indicator can be a line that connects the result to the corresponding point-of-interest object (e.g., a colored button) on the map 114.

The content component 116 can be configured to access a single type of the additional content 120 for presentation in association with the map results 112. The single type can be one of many different media types, such as an image (e.g., photograph) of the point of interest, a thumbnail (reduced) map of the point of interest and surrounding streets/avenues, a video clip, an audio clip, message, text, etc. Thus, in the case of the single type being an image, the image that corresponds to each result can be sized appropriately to enable image placement as the additional content for each result. Where the single type is textual only, the textual additional content can be customer reviews for each of the results, where the textual additional content space for each result is sized equally (or approximately equally within some predetermined variation threshold) for each result.

It is to be understood that in the disclosed architecture, certain components may be rearranged, combined, omitted, and additional components may be included. For example, the analysis component 106 and the content component 116 can be combined as a single module to execute the associated functionality. In another example, the content component 116 can receive/access/obtain the additional content 120 from sources such as mapping servers, search engines, and so on.

Additionally, in some embodiments, all or some of the components are present on the client, while in other embodiments some components may reside on a server or are provided by a local or remote service. For example, while in one implementation, the analysis component 106 and content component 116 can be online services, it can be the case that such capabilities can be implemented as part of a corporate intranet (enterprise), or in a more local case of on a user system such that local searches by an local search capability return results and additional content solely on a client device. In one example case, the user employs an office application to search locally for specific documents the results of which are limited, in which case, additional information associated with the results can be augmented with the additional content related to the results.

In all deployments, the disclosed architecture can optionally include a privacy component (not shown) that enables the user to opt in or opt out of exposing personal information. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

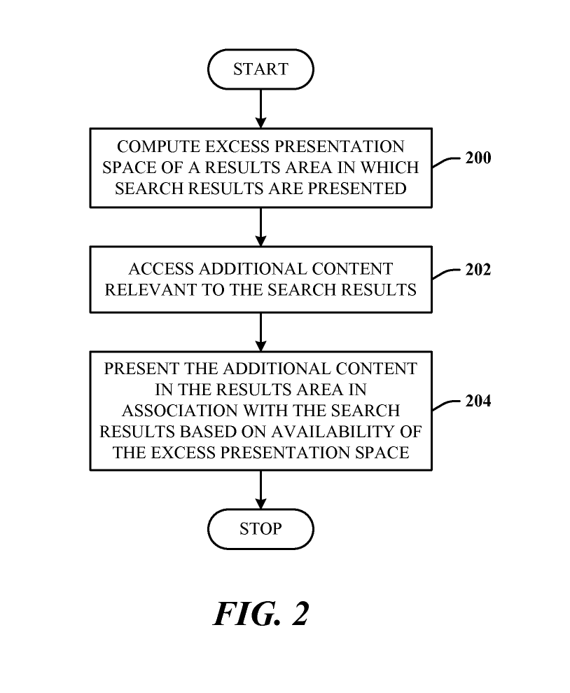

FIG. 2 illustrates a method in accordance with the disclosed architecture. At 200, excess presentation space of a results area in which search results are presented, is computed. At 202, additional content relevant to the search results is accessed. At 204, the additional content is presented in the results area in association with the search results based on availability of the excess presentation space.

The method can further comprise limiting the additional content and the search results to the results area. In other words, the results area is of a finite area and dimension. Thus, the additional content selected is formatted for utilization in the portion of excess presentation space allocated for a given result.

The method can further comprise restricting the additional content to non-advertising content. One purpose of the search result is to provide the user the information for which they are searching. As a result it should not include advertisements, although the disclosed architecture is not so limited.

The method can further comprise allocating result space for a given search result based on rank of the search result. That is, if a given search result (or set of top results) is the top-listed result it can be assumed that this result is the top-ranked result. Based on some measure of accuracy that the search result is the information the user desires, the amount of additional content for this result can be increased thereby requiring additional space for this content. Contrariwise, a lower-ranked result (or results) can then have reduced allocations of space for additional content since the amount of excess presentation space for all the results is finite.

In one implementation, the results can be automatically handled such that when perused by the user, the result receiving the user interaction (the “in-focus” result) is automatically expanded (and possibly zoomed-in) to show more of the additional content and result as a whole, than a result that is not with user interaction (an “out-of-focus” result).

The method can further comprise presenting the additional content of a given search result as relates to geographical information of a point of interest associated with the given search result. The method can further comprise presenting additional geographical information as the additional content to geographical results of a mapping application. The method can further comprise accessing a single type (e.g., media) of the additional content for presentation in association with the search results.

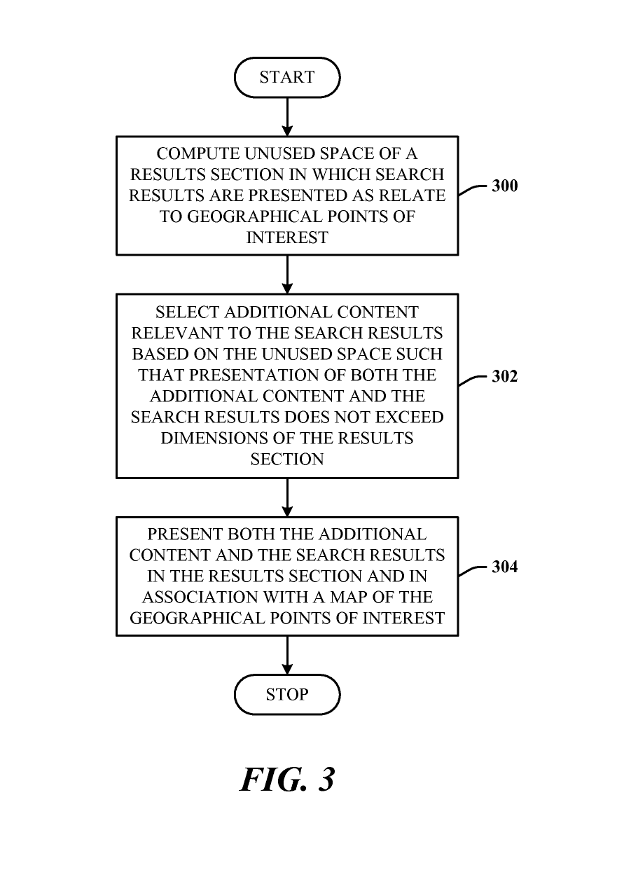

FIG. 3 illustrates an alternative method in accordance with the disclosed architecture. At 300, unused space of a results section in which search results are presented, is computed. The search results section can be multi-dimensional (e.g., length, width, depth, etc.). The search results can relate to geographical points of interest (e.g., restaurants, parks, centers, etc.). At 302, additional content relevant to the search results is selected based on the unused space such that presentation of both the additional content and the search results does not exceed dimensions of the results section. At 304, both the additional content and the search results are presented in the results section and in association with a map of the geographical points of interest. The map can be sufficiently large (or small) to present geographical locations of the results as well as other structures/routes/natural barriers that help the user identify the location and surrounding structure such as roads, building, etc.

The method can further comprise automatically selecting new additional content based on a new search in which the unused space has changed. When the user initiates a new search using a different query, the number of results may change, thereby affecting the size of the unused space. For example, a larger number of results in the finite size of the results section translates into less space for each result in which to add additional content. It also follows then that the method can further comprise adjusting an amount of the additional content selected to correspond to the unused space.

The method can further comprise selecting a single media type or multiple media types of the additional content to present with each of the search results. When the unused space has been determined, a single media type can be selected for each result. That single media type can be an image, for example, or strictly text. Thus, all results can be expanded using only images or only text. Alternatively, it can be the case where the media type of the additional content of a first result is different than the media type of the additional content of the second result—the first result is expanded using an image and the second result is expanded using text. It can also be the case, that there is sufficient additional space to add multiple media types (e.g., image, video clip, and text) for a given search result.

The method can further comprise presenting additional geographical information as the additional content to geographical results of a mapping application. In a mapping search environment, it is likely the user would want to see more information about the geographical points of interest such as address, customer reviews, access information such as for reservations, available of tickets, seats, and so on.

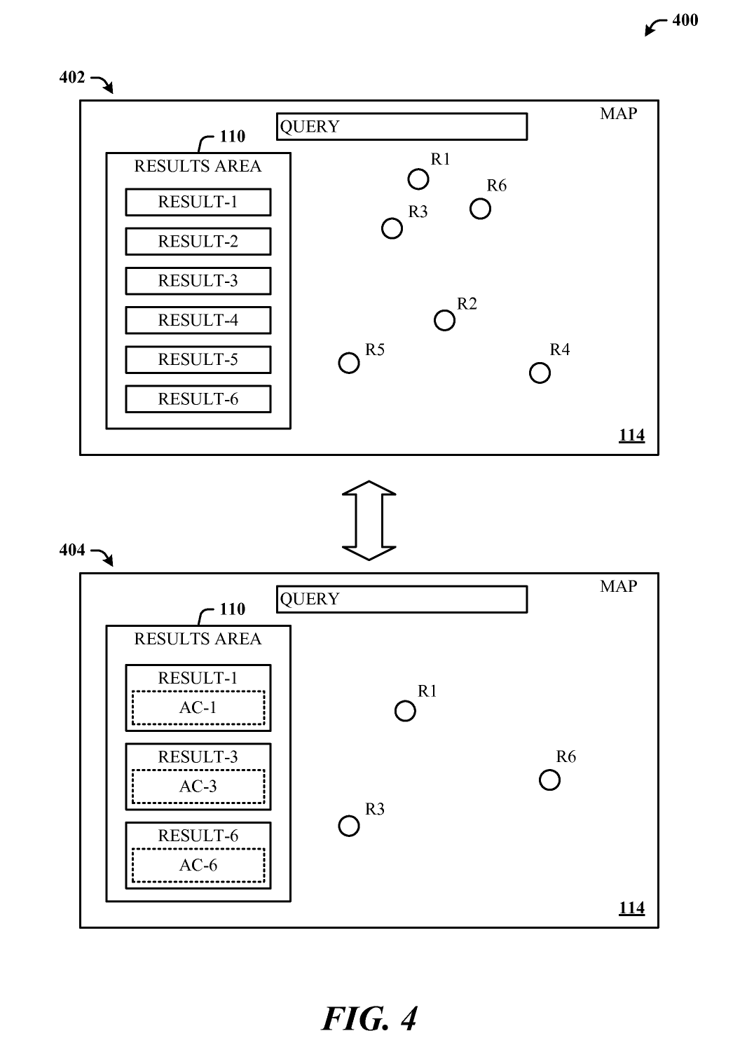

FIG. 4 illustrates a diagram 400 of a change in views of search results with a corresponding change of view of an associated map. Here, a top view 402 shows the results area 110 used in combination with the map 114. In the results area 110 are shown six results: Result-1, Result-2, Result-3, Result-4, Result-5, and Result-6. These six results correspond to six geographic locations on the map 114 designated as R1, R2, R3, R4, R5, and R6.

As the user interacts with the map 114, such as by zooming in, zooming out, dragging the map 114 in any direction to change the existing map view to a new map view, any one or more of the six locations R1-R6 may move from view, thereby affecting the corresponding results presented in the results area 110. For example, consider that the user chooses to see a more detailed view of three locations that appear to be clustered in a given area of the map 114, such as locations R1, R3, and R6. In order to see this zoomed-in view, the use can drag the map downward and then zoom-in on the cluster of three locations: R1, R3, and R6. This user action then causes the other three locations (R2, R4, and R5) to move out of the map view, as now shown in the lower view 404.

In response, the disclosed architecture operates to remove the corresponding three results (Result-2, Result-4, and Result-5) from the results area 110. Since the results area 110 is an area of fixed dimensions, in this case, the removal of the three results (Result-2, Result-4, and Result-5) introduces excess (or unused) space in the results area 110 along with the three remaining results (Result-1, Result-3, and Result-6). Thus, the unused space is computed and apportioned among the three results (Result-1, Result-3, and Result-6) for the automatic generation and insertion of additional content: Additional Content-1 (AC-1), Additional Content-3 (AC-3), and Additional Content-6 (AC-6). The additional content AC-1 relates to the location R1, the additional content AC-3 relates to the location R3, and additional content AC-6 relates to the location R6.

In a reversing operation that zooms out to then include the location R2 (not shown in the lower view 404), with the locations R1, R3, and R6 in the map view, the results in the results area 110 now include the result Result-2. In response, and although not shown, the disclosed architecture re-computes any unused portion (or space) of the results area 110, apportions the unused space among the now four results (Result-1, Result-2, Result-3, and Result-6) for additional content: Additional Content-1 (AC-1), Additional Content-2 (AC-2), Additional Content-3 (AC-3), and Additional Content-6 (AC-6). The additional content AC-1 relates to the location R1, the additional content AC-2 relates to the location R2, the additional content AC-3 relates to the location R3, and additional content AC-6 relates to the location R6. This interaction can continue as the user interacts with the map 114 to manipulate the dynamically generated results.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

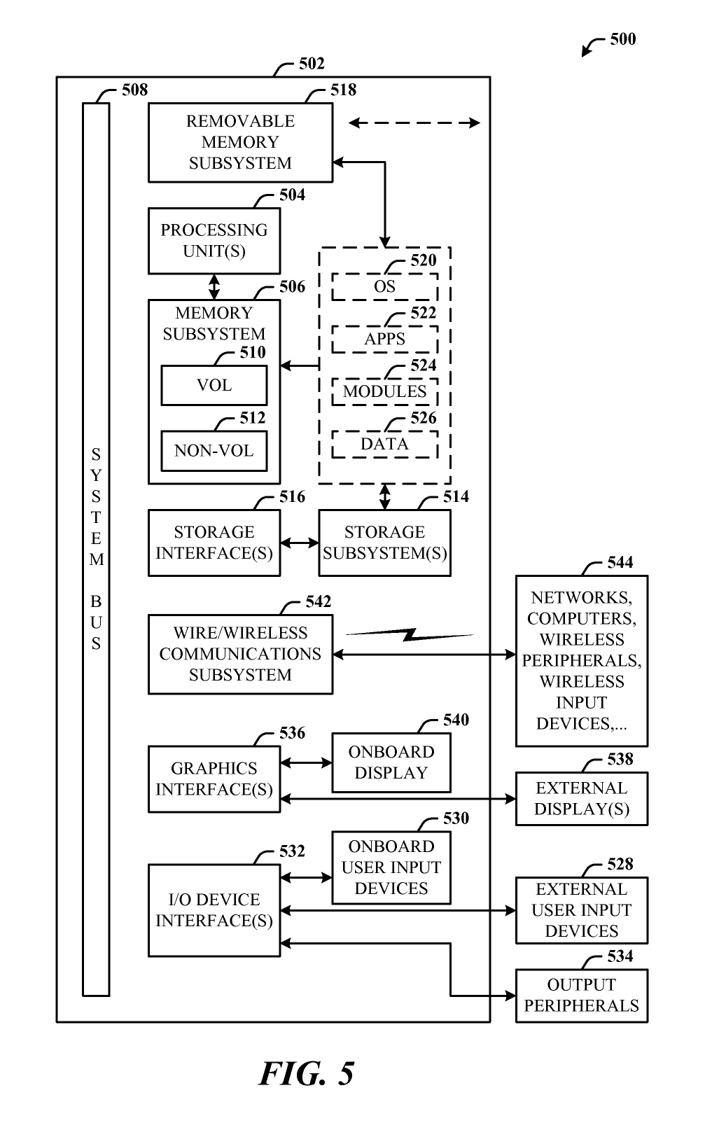

Referring now to FIG. 5, there is illustrated a block diagram of a computing system 500 that executes dynamic results in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having microprocessing unit(s) 504 (also referred to as microprocessor(s) and processor(s)), a computer-readable storage medium such as a system memory 506 (computer readable storage medium/media also include magnetic disks, optical disks, solid state drives, external memory systems, and flash memory drives), and a system bus 508. The microprocessing unit(s) 504 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 502 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 506 can include computer-readable storage (physical storage) medium such as a volatile (VOL) memory 510 (e.g., random access memory (RAM)) and a non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the microprocessing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components and circuits. The storage subsystem(s) 514 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The operating system 520, one or more application programs 522, other program modules 524, and/or program data 526 can include items and components of the system 100 of FIG. 1, the methods represented by the flowcharts of FIGS. 2 and 3, and the view 400 of FIG. 4, for example.

Generally, programs include routines, methods, data structures, other software components, etc., that perform particular tasks, functions, or implement particular abstract data types. All or portions of the operating system 520, applications 522, modules 524, and/or data 526 can also be cached in memory such as the volatile memory 510 and/or non-volatile memory, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 502, and include volatile and non-volatile internal and/or external media that is removable and/or non-removable. For the computer 502, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 502, programs, and data using external user input devices 528 such as a keyboard and a mouse, as well as by voice commands facilitated by speech recognition. Other external user input devices 528 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 502, programs, and data using onboard user input devices 530 such a touchpad, microphone, keyboard, etc., where the computer 502 is a portable computer, for example.

These and other input devices are connected to the microprocessing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

In another implementation, the disclosed architecture provides means for computing excess presentation space of a results area in which search results are presented; means for accessing additional content relevant to the search results; and means for presenting the additional content in the results area in association with the search results based on availability of the excess presentation space.

In other aspects thereof, the implementation provides means for limiting the additional content and the search results to the results area; means for restricting the additional content to non-advertising content; and means for allocating result space for a given search result based on rank of the search result.

In yet other aspects thereof, the implementation provides means for presenting the additional content of a given search result as relates to geographical information of a point of interest associated with the given search result; means for presenting additional geographical information as the additional content to geographical results of a mapping application; and, means for accessing a single type of the additional content for presentation in association with the search results.

In yet another implementation, the disclosed architecture provides means for computing unused space of a results section in which search results are presented as relate to geographical points of interest; means for selecting additional content relevant to the search results based on the unused space such that presentation of both the additional content and the search results does not exceed dimensions of the results section; and, means for presenting both the additional content and the search results in the results section and in association with a map of the geographical points of interest.

In other aspects thereof, this implementation provides means for automatically selecting new additional content based on a new search in which the unused space has changed; means for adjusting an amount of the additional content selected to correspond to the unused space; means for selecting a single media type or multiple media types of the additional content to present with each of the search results; and, means for presenting additional geographical information as the additional content to geographical results of a mapping application.

In another implementation, a system is provided, comprising an analysis component configured to compute excess presentation space of a results area, the results area comprises map results having content presented in association with a map; a content component configured to present additional content in the results area based on availability of the excess presentation space of the results area for improved user efficiency and interaction performance; and at least one hardware processor configured to execute computer-executable instructions in a device memory associated with the analysis component and the content component.

The additional content and map results are limited to a maximum presentation space of the results area. The additional content is non-advertising content. The additional content includes portions of content individually relevant to corresponding map results and the portions of content are distributed in equivalent amounts of space among the map results. The additional content is apportioned among the map results. The additional content is apportioned among the map results based on rank of the map results.

The additional content relates to geographical information of one or more points of interest identified in the map, the one or more points of interest visually associated with the map results. The content component is configured to access a single type of the additional content for presentation in association with the map results.

In another implementation, a method can be provided, comprising acts of: computing excess presentation space of a results area in which search results are presented; accessing additional content relevant to the search results; and presenting the additional content in the results area in association with the search results based on availability of the excess presentation space for improved user efficiency and interaction performance.

The method can further comprise any one or more of the following acts separately or in combination: limiting the additional content and the search results to the results area; restricting the additional content to non-advertising content; allocating result space for a given search result based on rank of the search result; presenting the additional content of a given search result as relates to geographical information of a point of interest associated with the given search result; presenting additional geographical information as the additional content to geographical results of a mapping application; and/or, accessing a single type of the additional content for presentation in association with the search results.

In yet another implementation, a method can be provided, comprising acts of: computing unused space of a results section in which search results are presented as relate to geographical points of interest; selecting additional content relevant to the search results based on the unused space such that presentation of both the additional content and the search results does not exceed dimensions of the results section; and presenting both the additional content and the search results in the results section and in association with a map of the geographical points of interest for improved user efficiency and interaction performance.

The method can further comprise any one or more of the following acts separately or in combination: automatically selecting new additional content based on a new search in which the unused space has changed; adjusting an amount of the additional content selected to correspond to the unused space; selecting a single media type or multiple media types of the additional content to present with each of the search results; and/or presenting additional geographical information as the additional content to geographical results of a mapping application.

What has been described above includes examples of the disclosed architecture. It is, of course, not possible to describe every conceivable combination of components and/or methodologies, but one of ordinary skill in the art may recognize that many further combinations and permutations are possible.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an analysis component configured to compute excess presentation space of a results area, the results area comprises map results having content presented in association with a map;
a content component configured to present additional content in the results area based on availability of the excess presentation space of the results area for improved user efficiency and interaction performance; and
at least one hardware processor configured to execute computer-executable instructions in a device memory associated with the analysis component and the content component.

2. The system of claim 1, wherein the additional content and map results are limited to a maximum presentation space of the results area.

3. The system of claim 1, wherein the additional content is non-advertising content.

4. The system of claim 1, wherein the additional content includes portions of content individually relevant to corresponding map results and the portions of content are distributed in equivalent amounts of space among the map results.

5. The system of claim 1, wherein the additional content is apportioned among the map results.

6. The system of claim 1, wherein the additional content is apportioned among the map results based on rank of the map results.

7. The system of claim 1, wherein the additional content relates to geographical information of one or more points of interest identified in the map, the one or more points of interest visually associated with the map results.

8. The system of claim 1, wherein the content component is configured to access a single type of the additional content for presentation in association with the map results.

9. A method, comprising acts of:
computing excess presentation space of a results area in which search results are presented;
accessing additional content relevant to the search results; and
presenting the additional content in the results area in association with the search results based on availability of the excess presentation space for improved user efficiency and interaction performance.

10. The method of claim 9, further comprising limiting the additional content and the search results to the results area.

11. The method of claim 9, further comprising restricting the additional content to non-advertising content.

12. The method of claim 9, further comprising allocating result space for a given search result based on rank of the search result.

13. The method of claim 9, further comprising presenting the additional content of a given search result as relates to geographical information of a point of interest associated with the given search result.

14. The method of claim 9, further comprising presenting additional geographical information as the additional content to geographical results of a mapping application.

15. The method of claim 9, further comprising accessing a single type of the additional content for presentation in association with the search results.

16. A method, comprising acts of:
computing unused space of a results section in which search results are presented as relate to geographical points of interest;
selecting additional content relevant to the search results based on the unused space such that presentation of both the additional content and the search results does not exceed dimensions of the results section; and
presenting both the additional content and the search results in the results section and in association with a map of the geographical points of interest for improved user efficiency and interaction performance.

17. The method of claim 16, further comprising automatically selecting new additional content based on a new search in which the unused space has changed.

18. The method of claim 16, further comprising adjusting an amount of the additional content selected to correspond to the unused space.

19. The method of claim 16, further comprising selecting a single media type or multiple media types of the additional content to present with each of the search results.

20. The method of claim 16, further comprising presenting additional geographical information as the additional content to geographical results of a mapping application.
